(19) United States
(12) Patent Application Publication
(10) Pub. No.: US 2012/0058406 A1
(43) Pub. Date: Mar. 8, 2012

(54) SOLID OXIDE FUEL CELL

(75) Inventors: Eon Soo LEE, Gyeongsangbuk-do (KR); Jae Hyuk JANG, Seoul (KR); Jae Hyoung GIL, Seoul (KR)

(73) Assignee: SAMSUNG ELECTRO-MECHANICS CO., LTD., Gyunggi-do (KR)

(21) Appl. No.: 13/170,129

(22) Filed: Jun. 27, 2011

(30) Foreign Application Priority Data
Sep. 2, 2010 (KR) 10-2010-0086048

(51) Int. Cl. H01M 8/06

(52) U.S. Cl. 429/425

(57) ABSTRACT

Disclosed herein is a solid oxide fuel cell. The solid oxide fuel cell 100 according to the present invention includes: a reforming support layer 110 formed in a tubular shape and reforming fuel supplied to the inside thereof; an anode 120 formed at the outer side of the reforming support layer 110; an electrolyte 130 formed at the outer side of the anode 120; and a cathode 140 formed at the outer side of the electrolyte 130. The solid oxide fuel cell 100 includes the reforming support layer 100, thereby making it possible to reduce the entire volume and weight of the fuel cell system without having a separate reformer.

### CROSS REFERENCE TO RELATED APPLICATION

This application claims the benefit of Korean Patent Application No. 10-2010-0086048, filed on Sep. 2, 2010, entitled “Solid Oxide Fuel Cell” which is hereby incorporated by reference in its entirety into this application.

### BACKGROUND OF THE INVENTION

1. Technical Field

The present invention relates to a solid oxide fuel cell.

2. Description of the Related Art

A fuel cell is an apparatus that directly converts chemical energy of fuel (hydrogen, LNG, LPG, or the like) and oxygen (air) into electricity and heat by electrochemical reaction. The existing power generation technologies should perform processes such as fuel combustion, steam generation, turbine driving, generator driving, or the like, while the fuel cell does not need to perform processes such as the fuel combustion, the turbine driving, or the like. As a result, the fuel cell is a new power generation technology capable of increasing generation efficiency without leading to environmental problems. The fuel cell little discharges air pollutants such as SO_{X}, NO_{X}, or the like, and generate less carbon dioxide, such that it can implement chemical-free, low-noise, non-vibration generation, or the like.

Types of fuel cells are various such as a phosphoric acid fuel cell (PAFC), an alkaline fuel cell (AFC), a proton exchange membrane fuel cell (PEMFC), a direct methanol fuel cell (DMFC), a solid oxide fuel cell (SOFC), or the like. Among others, the solid oxide fuel cell (SOFC) depends on activation polarization, which lowers overvoltage and irreversible loss to increase generation efficiency. Further, since the reaction rate in electrodes is rapid, the SOFC does not need expensive precious metals as an electrode catalyst. Therefore, the solid oxide fuel cell is an essential generation technology in order to entry a hydrogen economy society in the future.

FIG. 1 is a conceptual diagram showing a generation principle of a solid oxide fuel cell.

Reviewing a basic generation principle of a solid oxide fuel cell (SOFC) with reference to FIG. 1, when fuel is hydrogen (H₂) or carbon monoxide (CO), the following electrode reaction is performed in an anode 1 and a cathode 2.

Anode: CO+H₂O→H₂+CO₂

2H₂+2O²⁻→4e⁻+2H₂O

Cathode: O₂+4e⁻→2O²⁻

Entire reaction: H₂+CO+O₂→CO₂+H₂O

That is, electrons (e⁻) generated in the anode 1 are transferred to the cathode 2 through an external circuit 4 and at the same time, oxygen ions (O²⁻) generated in the cathode 2 are transferred to the anode 1 through an electrolyte 3. In addition, hydrogen (H₂) is combined with oxygen ion (O²⁻) in the anode 1 to generate electrons (e⁻) and water (H₂O). As a result, reviewing the entire reaction of the solid oxide fuel cell, hydrogen (H₂) or carbon monoxide (CO) are supplied to the anode 1 and oxygen is supplied to the cathode 2, such that carbon dioxide (CO₂) and water (H₂O) are generated.

However, when the fuel supplied to the solid oxide fuel cell is hydrocarbons such as propane, methane, butane, or the like, rather than hydrogen or carbon monoxide, the hydrocarbon-based fuel is reformed to hydrogen or carbon monoxide in the outside, which should be in turn supplied to the solid oxide fuel cell. Therefore, when the fuel is the hydrocarbons, a reformer is provided at the outside of the solid oxide fuel cell in order to reform fuel, such that the entire volume and weight of the fuel cell system are increased and the system is complex, thereby increasing the manufacturing costs and degrading the efficiency.

### SUMMARY OF THE INVENTION

The present invention has been made in an effort to provide a solid oxide fuel cell without a separate reformer by forming reforming support layers capable of reforming a hydrocarbon-based fuel at the inner side or the outer side of the fuel cell.

According to a preferred embodiment of the present invention, there is provided a solid oxide fuel cell, including: a reforming support layer formed in a tubular shape and reforming fuel supplied to the inside thereof; an anode formed at the outer side of the reforming support layer; an electrolyte formed at the outer side of the anode; and a cathode formed at the outer side of the electrolyte.

A cross section of the reforming support layer may have a circular shape, a flat-tubular shape, a triangular shape, a quadrangular shape, or a hexagonal shape.

The fuel may be hydrocarbons.

The reforming support layer and the anode may include nickel oxide (NiO) and yttria stabilized zirconia (YSZ), and a weight ratio of nickel oxide to yttria stabilized zirconia of the reforming support layer may be larger than that of nickel oxide to yttria stabilized zirconia of the anode.

The solid oxide fuel cell may further include an anode functional layer formed between the anode and the electrolyte.

The solid oxide fuel cell may further include a cathode functional layer formed between the electrolyte and the cathode.

According to another preferred embodiment of the present invention, there is provided a solid oxide fuel cell, including: a reforming support layer formed in a tubular shape and reforming fuel supplied the outside thereof; an anode formed at the inner side of the reforming support layer; an electrolyte formed at the inner side of the anode; and a cathode formed at the inner side of the electrolyte.

A cross section of the reforming support layer may have a circular shape, a flat-tubular shape, a triangular shape, a quadrangular shape, or a hexagonal shape.

The fuel may be hydrocarbons.

The reforming support layer and the anode may include nickel oxide (NiO) and yttria stabilized zirconia (YSZ), and a weight ratio of nickel oxide to yttria stabilized zirconia of the reforming support layer may be larger than that of nickel oxide to yttria stabilized zirconia of the anode.

The solid oxide fuel cell may further include an anode functional layer formed between the anode and the electrolyte.

The solid oxide fuel cell may further include a cathode functional layer formed between the electrolyte and the cathode.

### BRIEF DESCRIPTION OF THE DRAWINGS

FIG. 1 is a conceptual diagram showing a generation principle of a solid oxide fuel cell;

FIGS. 2 to 6 are cross-sectional views of a solid oxide fuel cell according to a first preferred embodiment of the present invention;

FIG. 7 is a perspective view of the solid oxide fuel cell shown in FIG. 2;

FIGS. 8 to 12 are cross-sectional views of a solid oxide fuel cell according to a second preferred embodiment of the present invention; and

FIG. 13 is a perspective view of the solid oxide fuel cell shown in FIG. 8.

### DESCRIPTION OF THE PREFERRED EMBODIMENTS

Various features and advantages of the present invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, O₂ and CH₄ shown in the drawings are merely an example for explaining an operating process of a fuel cell but do not limit the kinds of gas supplied to an anode or a cathode. Further, in describing the present invention, a detailed description of related known functions or configurations will be omitted so as not to obscure the gist of the present invention.

Hereinafter, preferred embodiments of the present invention will be described in detail with reference to the accompanying drawings.

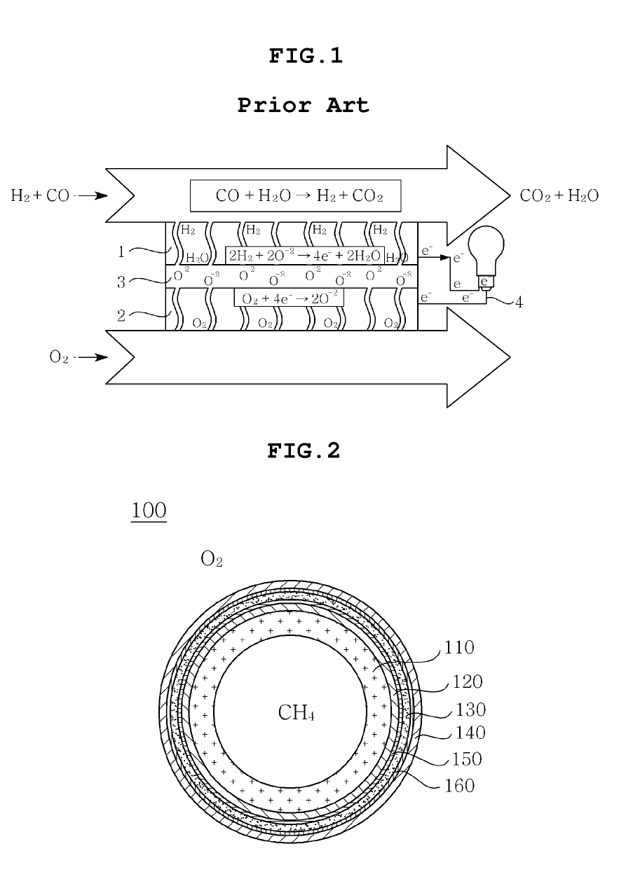

FIGS. 2 to 6 are cross-sectional views of a solid oxide fuel cell according to a first preferred embodiment of the present invention. FIG. 7 is a perspective view of the solid oxide fuel cell shown in FIG. 2.

As shown in FIGS. 2 to 7, a solid oxide fuel cell 100 according to the preferred embodiment according to the present invention is configured to include a reforming support layer 110 formed in a tubular shape and reforming fuel supplied to the inside thereof, an anode 120 formed at the outer side of the reforming support layer 110, an electrolyte 130 formed at the outer side of the anode 120, and a cathode 140 formed at the outer side of the electrolyte 130.

The reforming support layer 110 serves to support the anode 120, the electrolyte 130, and the cathode 140, all of which are formed at the outer side thereof, and to reform a hydrocarbon-based fuel. Therefore, the thickness of the reforming support layer 100 may be thicker than that of the anode 120, the electrolyte 130, and the cathode 140 in order to secure a supporting force and may be formed by an extrusion process, or the like. In addition, the reforming support layer 110 is formed in a tubular shape to reform fuel supplied to the inside thereof. In this configuration, the fuel is hydrocarbons including methane CH₄ described in the drawings and propane or butane and the fuel is reformed to hydrogen and carbon in the reforming support layer 110, which is then supplied to the anode 120 formed at the outside of the reforming support layer 110. Therefore, the reforming support layer 110 may be formed in a porous structure so as to deliver fuel. In addition, the reforming support layer 110 is made of nickel oxide (NiO) and yttria stabilized zirconia (YSZ) and may have a relatively higher weight ratio of nickel oxide to reform the hydrocarbon-based fuel. The detailed description thereof will be described below.

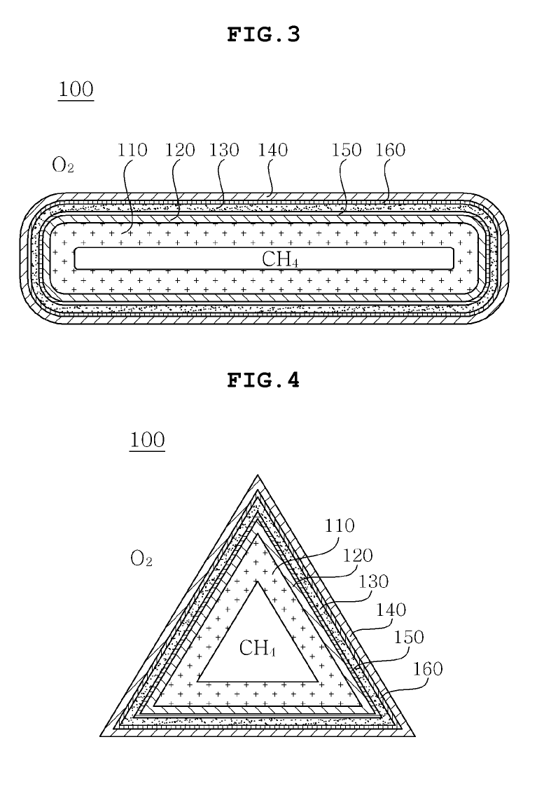

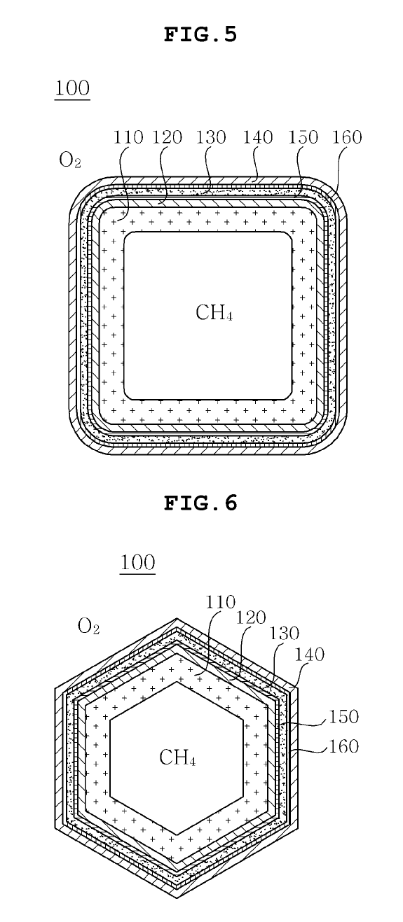

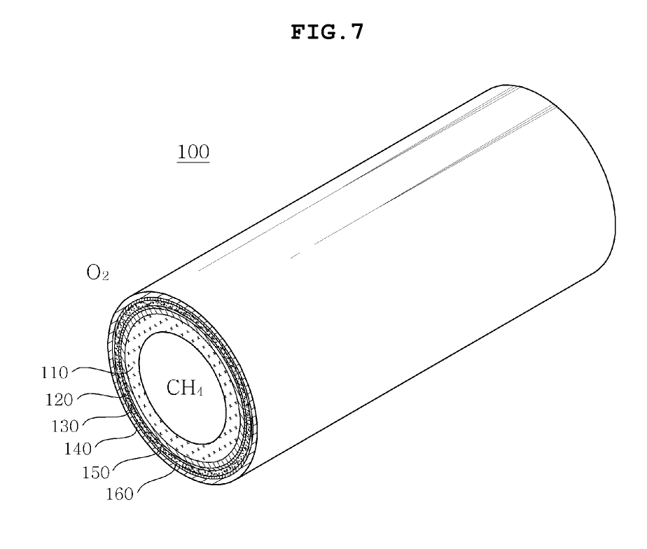

Meanwhile, the cross-sectional shape of the reforming support layer 110 is not specifically limited if it has a tubular shape; therefore, it may be formed in a circular shape (see FIG. 2), a flat-tubular shape (see FIG. 3), a triangular shape (see FIG. 4), a quadrangular shape (see FIG. 5), or a hexagonal shape (see FIG. 6). The cross-sectional shape of the reforming support layer 110 determines the cross-sectional shape of the final solid oxide fuel cell 100 and therefore, the solid oxide fuel cell 100 may also be formed in a circular shape (see FIG. 2), a flat-tubular shape (see FIG. 3), a triangular shape (see FIG. 4), a quadrangular shape (see FIG. 5), or a hexagonal shape (see FIG. 6). Meanwhile, the reforming support layer 110 is formed in a tubular shape, such that a manifold supplying fuel is securely encapsulated with the solid oxide fuel cell 100, thereby making it possible to prevent fuel from being leaked.

The anode 120 is supplied with the reformed fuel from the reforming support layer 110 to serve as an anode through the electrode reaction and is formed in the outer side of the reforming support layer 110. In this case, the anode 120 may be coated by a dry method such as a plasma spray method, an electrochemical deposition method, a sputtering method, an ion beam method, a ion injection method, etc., or a wet method such as a tape casting method, a spray coating method, a dip coating method, a screen printing method, a doctor blade method, or the like, and may be then formed by being heated at 1200° C. to 1300° C. In this case, the anode 120 is formed using the nickel oxide (NiO) and the yttria stabilized zirconia (YSZ). The nickel oxide is reduced to the metal nickel by hydrogen to show the electronic conductivity and the yttria stabilized zirconia (YSZ) shows the ion conductivity as oxide. Meanwhile, it can be appreciated that the components of the anode 120 and the above-mentioned reforming support layer 110 are similar to each other, as nickel oxide (NiO) and yttria stabilized zirconia (YSZ). However, the weight ratio of nickel oxide to yttria stabilized zirconia of the reforming support layer 110 may be larger than that of nickel oxide to yttria stabilized zirconia of the anode 120. For example, the weight ratio of nickel oxide to yttria stabilized zirconia of the anode 120 is 50:50 to 40:60, while the weight ratio of nickel oxide to yttria stabilized zirconia of the reforming support layer 110 is 60:40 to 80:20. The reforming support layer 110 includes a relatively larger amount of nickel oxide to reform the hydrocarbon-based fuel and the anode 120 includes a relatively larger amount of yttria stabilized zirconia to match the thermal expansion coefficient with the electrolyte 130, thereby making it possible to prevent cracks from being generated.

The electrolyte 130 serves to transfer oxygen ions generated in the cathode support 140 to the anode 120 and is formed at the outer side of the anode 120. In this configuration, the electrolyte 130 may be formed by coating yttria stabilized zirconia or scandium stabilized zirconia (ScSZ), GDC, LDC, or the like by a dry method or a wet method similar to that of the anode 120 and then sintering them at 1300° C. to 1500° C. In this case, in the yttria stabilized zirconia, since a portion of tetravalent zirconium ions is substituted for trivalent yttrium ions, one oxygen hole per two yttrium ions is generated therein and oxygen ions move through the hole at high temperature. Meanwhile, since the electrolyte 130 is a solid electrolyte, it has low ion conductivity as compared to the liquid electrolyte 130 such as an aqueous solution or a melting salt to reduce voltage drop caused due to resistance polarization. Therefore, it is preferable to form the electrolyte 160 as thinly as possible. In addition, when pores are generated in the electrolyte 130, it is to be noted that scratch is not generated since the efficiency is degraded due to the occurrence of a crossover phenomenon of directly reacting fuel with oxygen (air).

The cathode 140 is supplied with oxygen or air from the outside to serve as the anode through the electrode reaction and is formed in the outer side of the electrolyte 130. In this case, the cathode 140 may be formed by coating Lanthanum Strontium Manganite ((La_{0.84} Sr_{0.16}) MnO₃), etc., having high electronic conductivity by a dry method and a wet method similar to the anode 120 and then sintering it at 1200° C. to 1300° C. Meanwhile, oxygen is converted to oxygen ion by the catalyst operation of the lanthanum strontium manganite in the cathode 140, which is transferred to the anode 120 through the electrolyte 130.

Meanwhile, an anode functional layer 150 may be formed between the anode 120 and the electrolyte 130. In this configuration, the anode functional layer 150 serves to supplement the electrochemical activation of the anode 120. Therefore, the anode functional layer 150 may be formed using the nickel oxide (NiO) and the yttria stabilized zirconia (YSZ), similar to the anode 120. However, in order to reinforce the electrochemical activation, the anode functional layer 150 may be formed using fine yttria stabilized zirconia, not coarse yttria stabilized zirconia. Meanwhile, since the anode functional layer 150 performs a buffer role for forming the electrolyte 130 in the anode 120, it is preferable to minimize the surface roughness while having low porosity.

In addition, the cathode functional layer 160 may be formed between the electrolyte 130 and the cathode 140. In this configuration, the cathode functional layer 160 serves to supplement the electrochemical activation of the cathode 140. Therefore, the cathode functional layer 160 may be formed using the composite between the material forming the cathode 140 and the material forming the electrolyte 130. For example, the cathode functional layer 160 may be formed using the composite of the lanthanum strontium manganite forming the cathode 140 and the yttria stabilized zirconia forming the electrolyte 130. Meanwhile, the cathode functional layer 160 serves as a buffer member between the electrolyte 130 and the cathode 140, similar to the anode functional layer 150.

The solid oxide fuel cell 100 according to the present preferred embodiment includes the reforming support layer 110 at the innermost side thereof, such that it does not need the separate reformer, thereby making it possible to reduce the entire volume and weight of the fuel cell system. In addition, the present invention simplifies the configuration of the fuel cell system, thereby making it possible to save the manufacturing costs and increase the efficiency.

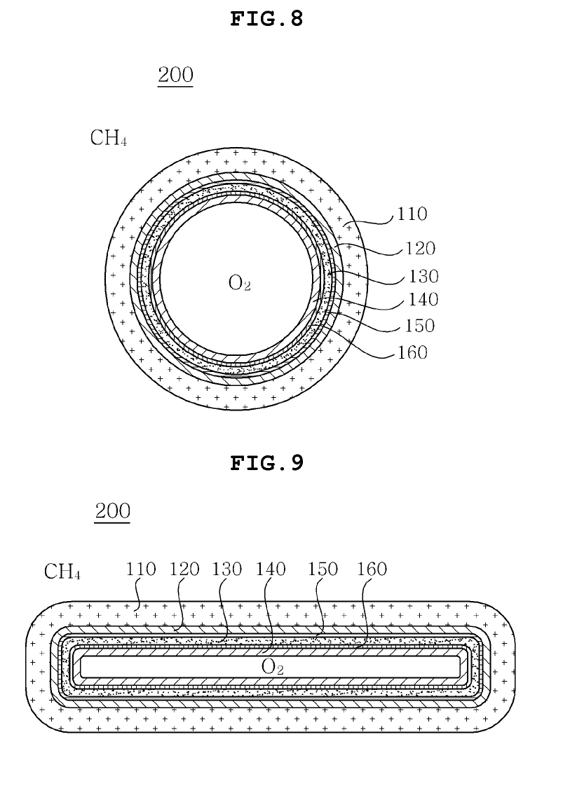

FIGS. 8 to 12 are cross-sectional views of a solid oxide fuel cell according to a second preferred embodiment of the present invention. FIG. 13 is a perspective view of the solid oxide fuel cell shown in FIG. 8.

As shown in FIGS. 8 to 13, a solid oxide fuel cell 200 according to the preferred embodiment according to the present invention is configured to include a reforming support layer 110 formed in a tubular shape and reforming fuel supplied to the outside thereof, an anode 120 formed at the inner side of the reforming support layer 110, an electrolyte 130 formed at the inner side of the anode 120, and a cathode 140 formed at the inner side of the electrolyte 130.

The largest difference between the solid oxide fuel cell 200 according to the preferred embodiment and the solid oxide fuel cell 100 according to the above-mentioned lint preferred embodiment is the formation position of the anode 120, the electrolyte 130, and the cathode 140. That is, in the solid oxide fuel cell 200 according to the preferred embodiment, the anode 120, the electrolyte 130, and the cathode 140 are formed at the inner side of the reforming support layer 100, while in the solid oxide fuel cell 100 according to the first preferred embodiment, the anode 120, the electrolyte 130, and the cathode 140 are formed at the outer side of the reforming support layer 110. Therefore, the present preferred embodiment mainly describes the above-mentioned difference and the repeated description will be omitted.

The reforming support layer 110 serves to support the anode 120, the electrolyte 130, and the cathode 140, all of which are formed at the inner side thereof, and to reform a hydrocarbon-based fuel. In this configuration, the reforming support layer 110 is formed in a tubular shape to reform fuel supplied to the outside thereof. In this configuration, the fuel is hydrocarbons including methane CH₄ described in the drawings as well as propane or butane and the fuel is reformed to hydrogen and carbon in the reforming support layer 110, which is then supplied to the anode 120 formed at the inner side of the reforming support layer 110.

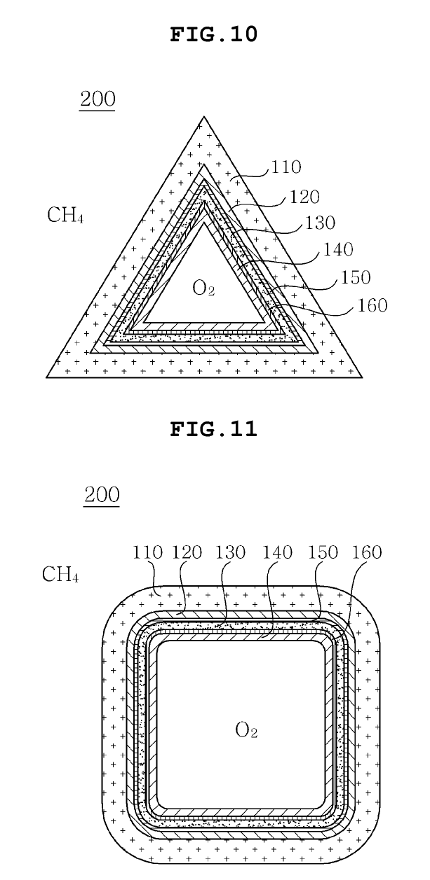

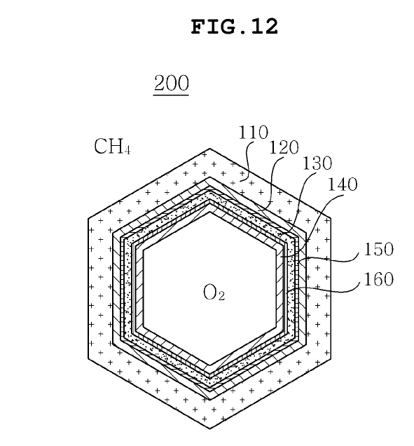

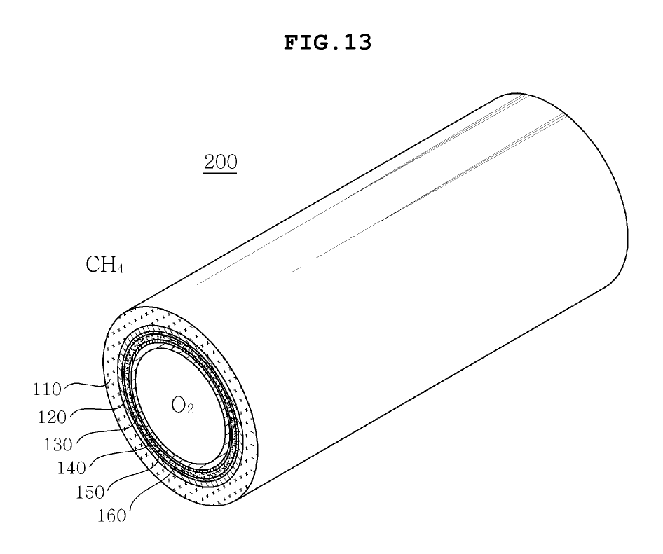

Meanwhile, the cross-sectional shape of the reforming support layer 110 may be formed in a circular shape (see FIG. 8), a flat-tubular shape (see FIG. 9), a triangular shape (see FIG. 10), a quadrangular shape (see FIG. 11), or a hexagonal shape (see FIG. 12). Meanwhile, the reforming support layer 110 is formed in a tubular shape, such that a manifold supplying oxygen or air is securely encapsulated with the solid oxide fuel cell 100, thereby making it possible to prevent oxygen or air from being leaked.

The anode 120 is supplied with the reformed fuel from the reforming support layer 110 to serve as an anode through the electrode reaction and is formed at the inner side of the reforming support layer 110. In this configuration, the anode 120 may be formed using the nickel oxide (NiO) and the yttria stabilized zirconia (YSZ), similar to the reforming support layer 110. In this case, the weight ratio of nickel oxide to yttria stabilized zirconia of the reforming support layer 110 may be larger than that of nickel oxide to yttria stabilized zirconia of the anode 120.

The electrolyte 130 serves to transfer oxygen ions generated in the cathode 140 to the anode 120 and is formed at the inner side of the anode 120. In this case, the electrolyte 130 may be formed using the yttria stabilized zirconia or the scandium stabilized zirconia (ScSz), GDC, LDC, or the like. In this case, in the yttria stabilized zirconia, since a portion of tetravalent zirconium ions is substituted for trivalent yttrium ions, one oxygen hole per two yttrium ions is generated therein and oxygen ions move through the hole at high temperature.

The cathode 140 is supplied with oxygen or air from the inside to serve as the anode through the electrode reaction and is formed at the inner side of the electrolyte 130. In this case, the cathode 140 may be formed using lanthanum strontium manganite ((La_{0.84}Sr_{0.16}) MnO₃), etc., having high electronic conductivity. In addition, oxygen is converted to oxygen ion by the catalyst operation of the lanthanum strontium manganite in the cathode 140, which is transferred to the anode 120 through the electrolyte 130.

Meanwhile, an anode functional layer 150 may be formed between the anode 120 and the electrolyte 130. In this configuration, the anode functional layer 150 serves to supplement the electrochemical activation of the anode 120. Therefore, the anode functional layer 150 may be formed using the nickel oxide (NiO) and the yttria stabilized zirconia (YSZ), similar to the anode 120. In addition, the anode functional layer 150 serves as the buffer member between the anode 120 and the electrolyte 130.

In addition, the cathode functional layer 160 may be formed between the electrolyte 130 and the cathode 140. In this configuration, the cathode functional layer 160 serves to supplement the electrochemical activation of the cathode 140. Therefore, the cathode functional layer 160 may be formed using the composite of the lanthanum strontium manganite forming the cathode 140 and the yttria stabilized zirconia forming the electrolyte 130. Meanwhile, the cathode functional layer 160 serves as the buffer member between the electrolyte 130 and the cathode 140, similar to the anode functional layer 150.

The solid oxide fuel cell 200 according to the present preferred embodiment includes the reforming support layer 110 formed at the outermost side thereof so that it does not need the separate reformer. Therefore, the present invention can reduce the entire volume and weight of the fuel cell system and simplifies the configuration of the fuel cell system, thereby making it possible to save the manufacturing costs and increase the efficiency.

According to the present invention, the fuel cell has the reforming support layers mounted at the innermost side or the outermost side of the fuel cell without having the separate reformer, thereby making it possible to reduce the entire volume and weight of the fuel cell system.

In addition, the present invention simplifies the configuration of the fuel cell system, thereby making it possible to save the manufacturing costs and to increase the efficiency.

Although the preferred embodiments of the present invention have been disclosed for illustrative purposes, they are for specifically explaining the present invention and thus a solid oxide fuel cell according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A solid oxide fuel cell, comprising:
a reforming support layer formed in a tubular shape and reforming fuel supplied to the inside thereof;
an anode formed at the outer side of the reforming support layer;
an electrolyte formed at the outer side of the anode; and
a cathode formed at the outer side of the electrolyte.

2. The solid oxide fuel cell as set forth in claim 1, wherein a cross section of the reforming support layer has a circular shape, a flat-tubular shape, a triangular shape, a quadrangular shape, or a hexagonal shape.

3. The solid oxide fuel cell as set forth in claim 1, wherein the fuel is hydrocarbons.

4. The solid oxide fuel cell as set forth in claim 1, wherein the reforming support layer and the anode include nickel oxide (NiO) and yttria stabilized zirconia (YSZ), and
a weight ratio of nickel oxide to yttria stabilized zirconia of the reforming support layer is larger than that of nickel oxide to yttria stabilized zirconia of the anode.

5. The solid oxide fuel cell as set forth in claim 1, further comprising an anode functional layer formed between the anode and the electrolyte.

6. The solid oxide fuel cell as set forth in claim 1, further comprising a cathode functional layer formed between the electrolyte and the cathode.

7. A solid oxide fuel cell, comprising:
a reforming support layer formed in a tubular shape and reforming fuel supplied the outside thereof;
an anode formed at the inner side of the reforming support layer;
an electrolyte formed at the inner side of the anode; and
a cathode formed at the inner side of the electrolyte.

8. The solid oxide fuel cell as set forth in claim 7, wherein a cross section of the reforming support layer has a circular shape, a flat-tubular shape, a triangular shape, a quadrangular shape, or a hexagonal shape.

9. The solid oxide fuel cell as set forth in claim 7, wherein the fuel is hydrocarbons.

10. The solid oxide fuel cell as set forth in claim 7, wherein the reforming support layer and the anode include nickel oxide (NiO) and yttria stabilized zirconia (YSZ), and
a weight ratio of nickel oxide to yttria stabilized zirconia of the reforming support layer is larger than that of nickel oxide to yttria stabilized zirconia of the anode.

11. The solid oxide fuel cell as set forth in claim 7, further comprising an anode functional layer formed between the anode and the electrolyte.

12. The solid oxide fuel cell as set forth in claim 7, further comprising a cathode functional layer formed between the electrolyte and the cathode.
